(19) United States
(12) Patent Application Publication
(10) Pub. No.: US 2024/0006873 A1
(43) Pub. Date: Jan. 4, 2024

(54) TECHNOLOGY TO RESOLVE CONNECTOR DAMAGE DUE TO ARCING

(71) Applicant: Intel Corporation, Santa Clara, CA (US)

(72) Inventors: Navneet Kumar Singh, Bangalore (IN); Shailendra Singh Chauhan, Bengaluru (IN); Aiswarya Pious, Bengaluru (IN); Amarjeet Kumar, Bangalore (IN); Samarth Alva, Bangalore (IN)

(21) Appl. No.: 17/852,530

(22) Filed: Jun. 29, 2022

(51) Int. Cl. H02H 5/00; H01R 13/66

(52) U.S. Cl. CPC H02H 5/00; H01R 13/6683; H01R 24/60

(57) ABSTRACT

Systems, apparatuses and methods may provide for power adapter technology that includes an adapter plug having a housing, a plurality of contacts positioned within the housing, wherein the plurality of contacts includes one or more configuration channel contacts, and a piezoelectric membrane positioned on an external surface of the housing, wherein the piezoelectric membrane is electrically connected to the one or more configuration channel contacts. Additionally, sink device technology may detect a signal from the piezoelectric membrane of the adapter plug via the configuration channel contact(s), wherein the signal indicates user contact with the adapter plug, and disconnect a bulk capacitor from a receptacle adjacent to the adapter plug in response to a disconnect condition associated with the user contact.

### TECHNICAL FIELD

Embodiments generally relate to electrical interfaces. More particularly, embodiments relate to technology to resolve connector damage due to arcing.

### BACKGROUND

Universal Serial Bus (USB) technology (e.g., Universal Serial Bus Type-C Cable and Connector Specification, Release 2.0, August 2019, USB Implementers Forum) provides for charging and/or operating power to be supplied from a source device to a sink device connected to the source device. For example, a laptop computer might negotiate a power delivery setting with an external charger (e.g., adapter) in which the external charger supplies (e.g., as a source device) power to the laptop computer (e.g., as a sink device). In such a case, the external charger provides the power to the laptop computer via a USB Type-C connector (e.g., plug) that is inserted (e.g., by a user) into a USB Type-C receptacle (e.g., port) on the laptop computer.

If the user removes/unplugs the connector from the receptacle during operation, a voltage difference may exist between contacts within the connector and contacts within the receptacle. Since the construction of USB Type-C connectors and receptacles calls for relatively tight spacing between the contacts, removal of the adapter may lead to an electrical field large enough to breakdown the air between the connector and the receptacle. As a result, a continuous spark or arcing may occur. Indeed, the continuous energy may be sufficient to cause damage to the connector and/or receptacle.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of an example of arcing between an adapter plug and a computing system receptacle;

FIG. 2A is a perspective view of an example of an adapter plug having a piezoelectric membrane according to an embodiment;

FIG. 2B is an end view of the adapter plug in FIG. 2A;

FIG. 2C is a sectional view of the adapter plug in FIG. 2A;

FIG. 3 is an illustration of an example of a configuration channel line according to an embodiment;

FIG. 4A is an illustration of an example of user contact with an adapter plug according to an embodiment;

FIG. 4B is a sectional plan view of an example of an electrically conductive pillar according to an embodiment;

FIG. 4C is a sectional perspective view of an example of an electrically conductive pillar according to an embodiment;

FIG. 5 is a schematic view of an example of a power delivery interface according to an embodiment;

FIG. 6 is a flowchart of an example of a method of operating a controller according to an embodiment;

FIG. 7 is a signaling diagram of an example of a sequence of communications between a Type-C supply and a laptop according to an embodiment;

FIG. 8 is a block diagram of an example of a performance-enhanced computing system according to an embodiment; and

FIG. 9 is an illustration of an example of a semiconductor package apparatus according to an embodiment.

### DETAILED DESCRIPTION OF EMBODIMENTS

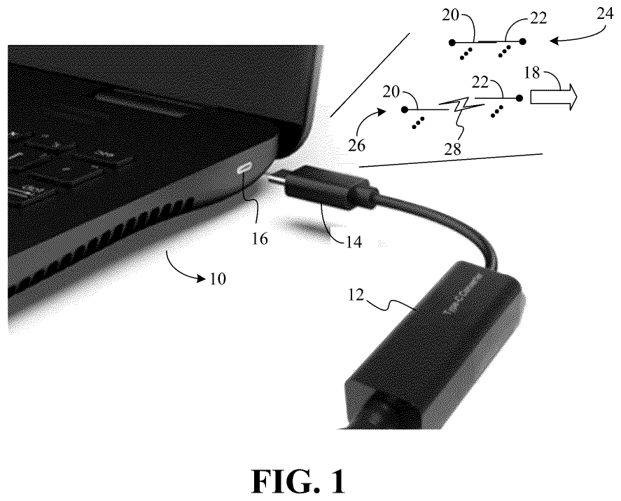

Turning now to FIG. 1, a scenario is shown in which a computing system 10 (e.g., laptop/notebook computer) receives power from an adapter 12 (e.g., alternating current/AC adapter) via a plug 14 (e.g., connector replacing a barrel power jack) that is inserted into a receptacle 16 (e.g., port, socket) of the computing system 10 during a connected state 24. The receptacle 16 may include one or more port contacts 20 (e.g., bus voltage/Vbus contacts) that mate with one or more connector contacts 22 within the plug 14 during the connected state 24. Thus, the adapter 12 might apply a direct current (DC) voltage of, for example, 20 Volts (V) or 48V to the connector contact(s) 22, wherein the DC voltage is transferred to the port contact(s) 20 during the connected state 24. Additionally, the port contacts(s) 20 may be electrically coupled (e.g., via one or more switches, not shown) to a bulk capacitor (not shown) and other components (e.g., system on chip/SoC) within the computing system 10.

In the illustrated example, an unplug event 18 occurs, where the user removes the plug 14 from the receptacle 16 while the adapter 12 is supplying power to the computing system 10. Thus, the user contact results in a disconnected state 26. Conventionally, the port contact(s) 20 may remain connected to the bulk capacitor during the disconnected state 26. Accordingly, the voltage level of the port contact(s) 20 may decrease relatively quickly as the bulk capacitor discharges stored current into the computing system 10 (e.g., acting as a small battery). Additionally, the adapter 12 may take more time (e.g., 650 milliseconds (ms)) to shut down the source output voltage to the connector contact(s) 22 once the disconnected state 26 is detected. Thus, the voltage difference between the contact(s) 20, 22 and the tight spacing between the contact(s) 20, 22 may be enough to create an electrical field large enough to breakdown the air between the contact(s) 20, 22 and generate a spark 28 (e.g., arcing) from the connector contact(s) 22 to the port contact(s) 20. The spark 28 may damage the contact(s) 20, 22 over time (e.g., via corrosion) and may present a safety hazard.

As will be discussed in greater detail, the technology described herein provides for automatically anticipating the disconnected state 26 and disconnecting the bulk capacitor from the port contact(s) 20 (e.g., reducing the primary load of the sink device). As a result, the voltage level of the port contact(s) 20 may remain at a similar voltage level of the connector contact(s) 22 at the onset of the disconnected state 26. The technology described herein therefore enables the spark 28 to be eliminated, which maintains the condition of the contact(s) 20, 22 (e.g., eliminating corrosion) and/or improves safety.

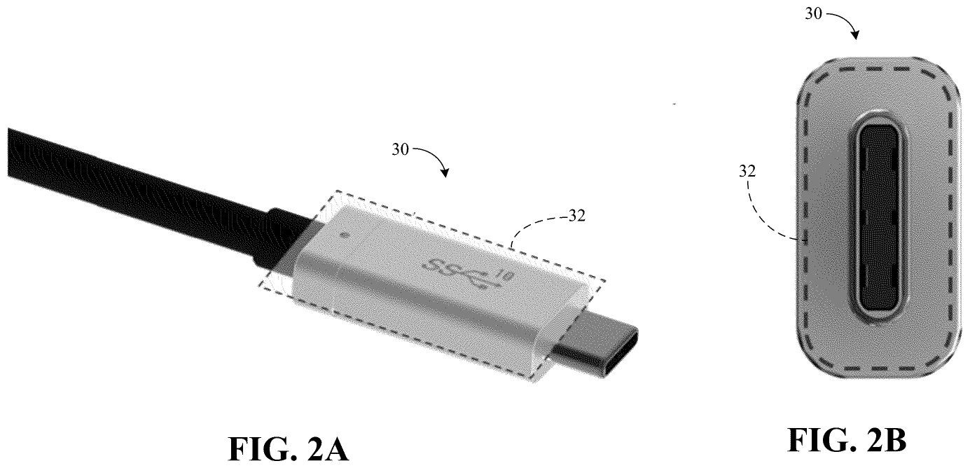

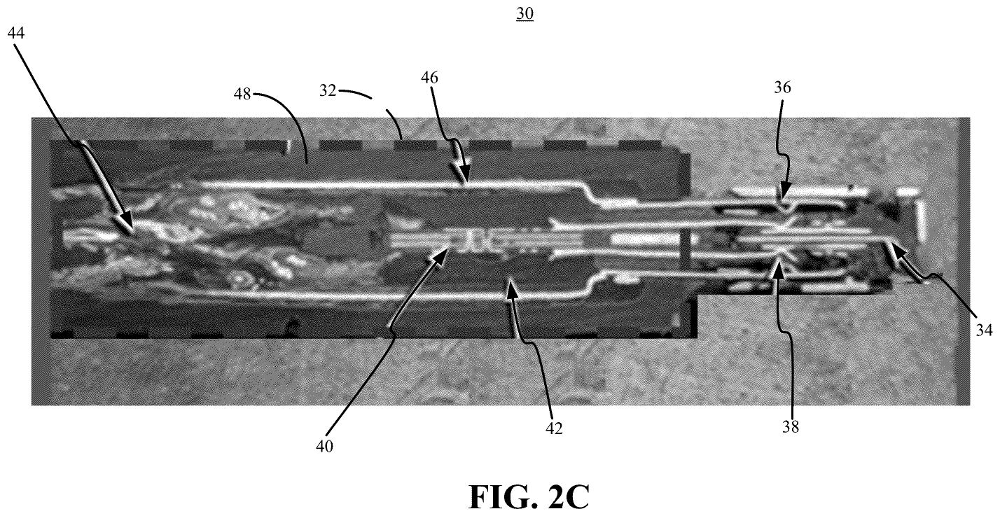

With continuing reference to FIGS. 2A-2C, an adapter plug 30 is shown, wherein the adapter plug 30 includes a piezoelectric membrane 32 (e.g., transducer). The adapter plug 30 may be readily substituted for the adapter plug 14 (FIG. 1), already discussed. In one example, the adapter plug 30 is compliant with a USB Type-C standard. Thus, the adapter plug 30 may support standard power range (SPR, e.g., 20V, 5A (amps), 100 W (Watts)) and/or extended power range (EPR, e.g., 48V, 5A, 240 W) power delivery. The EPR power delivery setting may be particularly advantageous in telecommunications applications.

As best shown in FIG. 2C, the adapter plug 30 includes a midplate 34 (e.g., ground), a spring 36 (e.g., radio frequency interference/RFI spring) and a plurality of copper contacts 38 (e.g., including configuration channel/CC contacts, bus voltage contacts, etc.). In an embodiment, the copper contacts 38 are coupled to a circuit board 40 (e.g., printed circuit board/PCB, paddle card), which is encompassed by an epoxy potting 42. In one example, the circuit board 40 is coupled to a wiring harness 44 that provides connectivity to an adapter. The adapter plug 30 may also include a shell 46 (e.g., steel), wherein the piezoelectric membrane 32 is positioned on an external surface of a housing 48 (e.g., overmold) around the shell 46. The piezoelectric membrane 32 may be coupled to the housing 48 via a suitable process such as, for example, chemical vapor deposition (CVD), sputtering (e.g., sputter deposition), and so forth.

As will be discussed in greater detail, the piezoelectric membrane 32 may be electrically connected to one or more configuration channel contacts. In such a case, when a user grasps/contacts the piezoelectric membrane 32, an electrical signal (e.g., voltage transition from low to high) is transferred to the receptacle of the computing system via the CC contact(s), wherein the electrical signal indicates user contact with the adapter plug 30. Upon receipt of the electrical signal, the computing system may begin to monitor the receptacle for a disconnect condition (e.g., CC line state change and/or bus voltage reduction within a predefined amount of time). If the disconnect condition is detected, the computing system may then disconnect a bulk capacitor (e.g., 1000′ (microfarad) capacitor) from the receptacle. In an embodiment, disconnection of the bulk capacitor from the receptacle prevents a current arc from the adapter plug 30 to the receptacle.

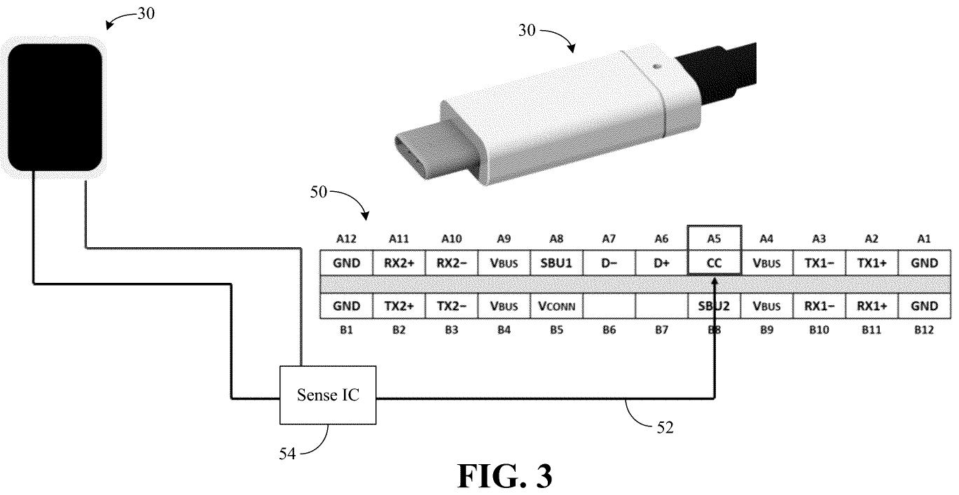

FIG. 3 shows a pin configuration 50 for the adapter plug 30, wherein the pin configuration 50 includes a CC line 52. The output of the piezoelectric membrane may be coupled to the CC line 52 either directly or indirectly through a sense integrated circuit (IC) 54. For example, the sense IC 54 might use one or more threshold values to determine when to assert and/or deassert the signal on the CC line 52. The CC line 52 may also be used to negotiate a power delivery setting (e.g., SRP, ERP) between the adapter plug 30 and the computing system.

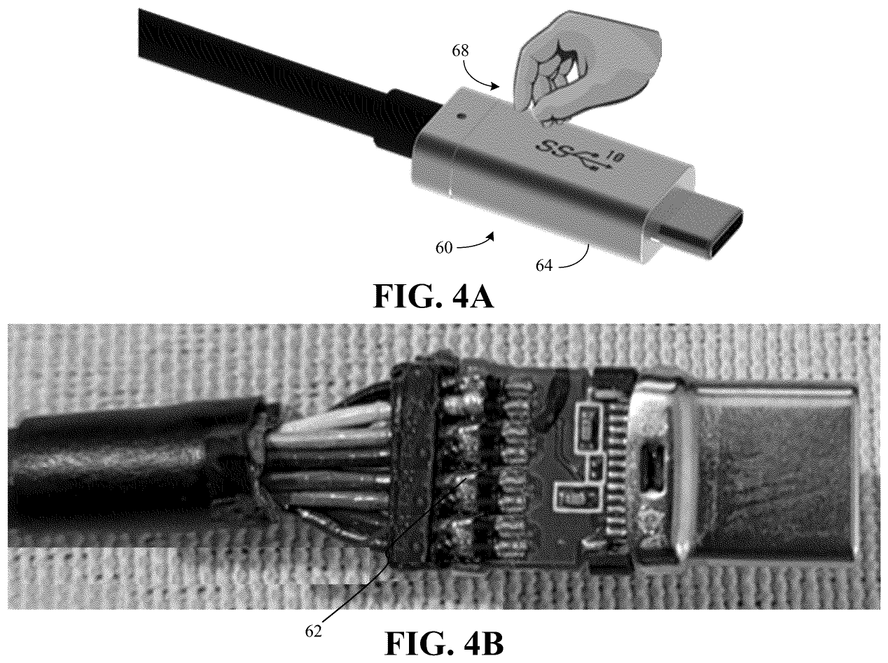

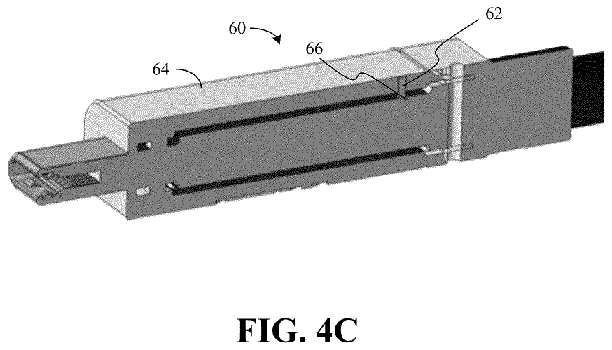

FIGS. 4A-4C show an example of an adapter plug 60 in which an electrically conductive pillar 62 interconnects a piezoelectric membrane 64 with a CC contact 66. Thus, user contact 68 with the piezoelectric membrane 64 generates/triggers a signal on the CC contact 66. In an embodiment, the adapter plug 60 also includes one or more bus voltage contacts, wherein the technology described herein eliminates arcing from the bus voltage contacts to an adjacent receptacle.

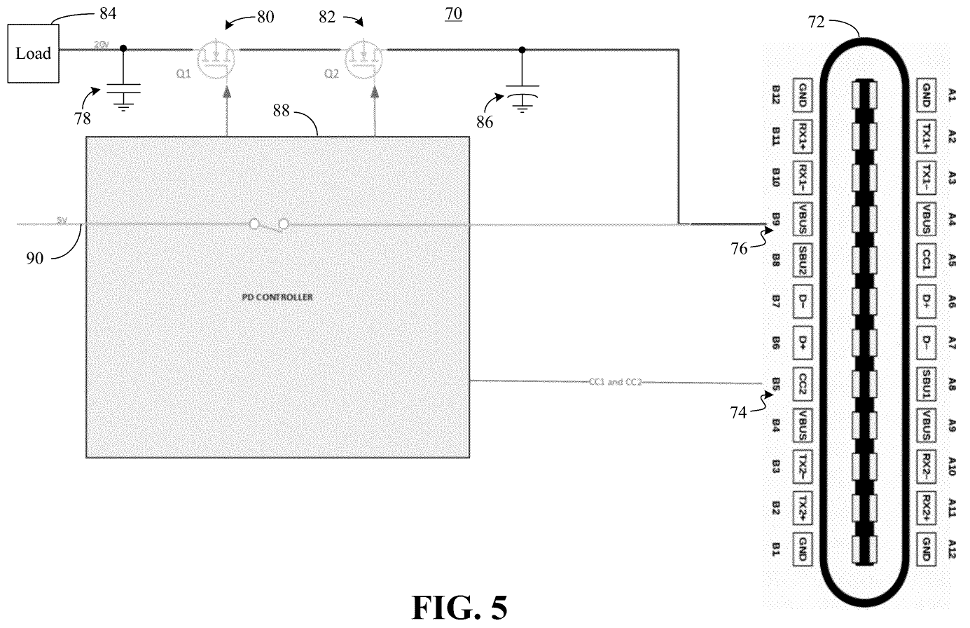

Turning now to FIG. 5, a power delivery interface 70 (e.g., located on a motherboard of a computing system) is shown in which a receptacle 72 includes one or more CC lines 74 (e.g., CC1, CC2), one or more bus voltage lines 76, and so forth. In an embodiment, the bus voltage line(s) 76 are coupled to a bulk capacitor 78 and a load 84 (e.g., SoC) via a first switch 80 (Q1, e.g., field effect transistor/FET) and a second switch 82 (Q2, e.g., FET). The illustrated power delivery interface 70 also includes an input capacitor 86 connected to the receptacle 72 via the bus voltage line 76.

Upon connection of the receptacle 72 with an adapter plug (not shown), a power delivery (PD) controller 88 may negotiate a power delivery setting (e.g., sink device status receiving SPR or EPR power delivery) with the adapter plug over the CC line(s) 74. A low voltage line 90 may be activated while the PD negotiations are underway. Once the PD negotiations are complete, the PD controller 88 may open the low voltage line 90 and enable the delivery of the negotiated level of power via the switches 80, 82 (e.g., controlling the slew rate).

The PD controller 88 includes logic (e.g., logic instructions, configurable logic hardware, fixed-functionality logic hardware, etc., not shown) to detect a signal from a piezoelectric membrane of the adapter plug, wherein the signal indicates user contact with the adapter plug. In one example, the signal is detected via the CC line(s) 74. The PD controller 88 may also disconnect the bulk capacitor 78 from the receptacle 72 in response to a disconnect condition associated with the user contact. In one example, the PD controller 88 monitors the receptacle 72 for the disconnect condition in response to the signal. Additionally, the PD controller 88 may disconnect the bulk capacitor 78 from the receptacle 72 by deactivating the switches 80, 82.

In an embodiment, the disconnect condition includes a state change in the CC line(s) 74 within a predetermined amount of time, a voltage reduction in the bus voltage line 76, etc., or any combination thereof. For example, the CC contact in the adapter plug is typically longer than the other contacts within the adapter plug. Thus, a state change in the CC line(s) 74 may be indicative that the user contact culminated in an unplug event. Additionally, a reduction in the voltage on the bus voltage line 76 may be indicative that the bulk capacitor 78 has begun discharging due to an unplug event. In either case, disconnecting the bulk capacitor 78 from the receptacle 72 prevents the voltage difference between the bus voltage line 76 and the bus voltage contacts of the adapter plug from being great enough to trigger arcing. In an example, the input capacitor 86 remains connected to the receptacle 72 while the bulk capacitor 78 is disconnected from the receptacle 72. The illustrated input capacitor 86 does not discharge as quickly as the bulk capacitor 78 because the input capacitor 86 does not provide current to the load 84 during the unplug event.

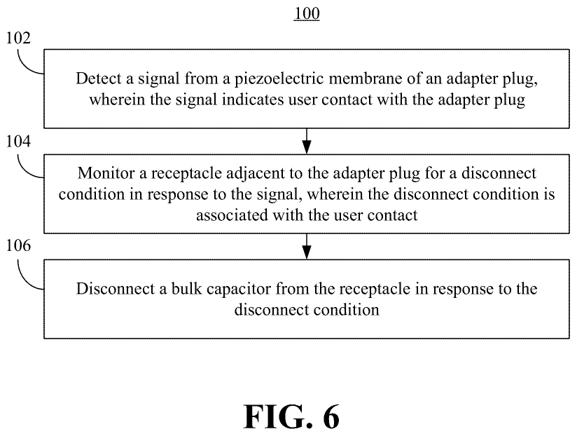

FIG. 6 shows a method 100 of operating a controller. The method 100 may generally be implemented in a controller such as, for example, the PD controller 88 (FIG. 5), already discussed. More particularly, the method 100 may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic include suitably configured programmable logic arrays (PLAs), field programmable gate arrays (FPGAs), complex programmable logic devices (CPLDs), and general purpose microprocessors. Examples of fixed-functionality logic include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

The illustrated processing block 102 provides for detecting a signal from a piezoelectric membrane of an adapter plug, wherein the signal indicates user contact with the adapter plug. In one example, block 102 negotiates a power delivery setting with the adapter plug via a configuration channel line prior to detecting the signal from the piezoelectric membrane. Block 104 monitors a receptacle adjacent to the adapter plug for a disconnect condition in response to the signal, wherein the disconnect condition is associated with the user contact. The disconnect condition may include, for example, a configuration channel line state change and/or a bus voltage reduction (e.g., of 5V) within a predetermined amount of time. Block 104 may detect the signal via a configuration channel line. Block 106 disconnects a bulk capacitor from the receptacle in response to the disconnect condition. In an embodiment, block 106 deactivates one or more switches connected between the bulk capacitor and the receptacle. Additionally, an input capacitor may remain connected to the receptacle while the bulk capacitor is disconnected from the receptacle.

Disconnection of the bulk capacitor from the receptacle therefore prevents a current arc from the adapter plug to the receptacle. Accordingly, the method 100 enhances performance at least to the extent that preventing arcing reduces damage to the receptacle and/or adapter plug. Arcing prevention also improves safety.

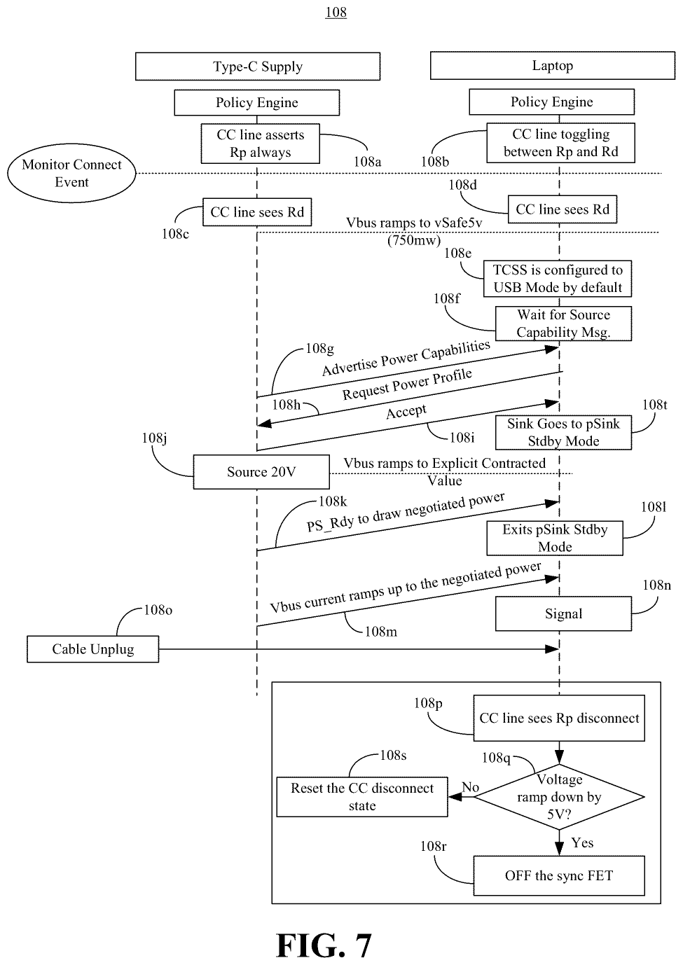

FIG. 7 shows a signaling diagram 108 (108a-108t) of an example of a sequence of communications between a Type-C supply (e.g., adapter) and a laptop (e.g., computing system). In the illustrated example, a policy engine of the Type-C supply continually asserts a pull-up resistance (Rp) value on a CC line at supply block 108a and a policy engine of the laptop toggles the CC line between a pull-up resistance value and a pull-down (Rd) resistance value at laptop block 108b. Thus, the Type-C supply observes the pull-down resistance value at supply block 108c and the laptop observes the pull-up resistance value at supply block 108d while monitoring for a connect event. The bus voltage line then ramps to a safe voltage of, for example, 5V at 750 mW (milliWatts).

At laptop block 108e, the Type-C subsystem (TCSS) is configured to operate in USB mode by default. Laptop block 108f then waits for a source capability message. The supply then sends an advertisement message 108g that indicates the power capabilities of the supply. The laptop returns a request message 108h, which requests a power profile. The supply may also return an acceptance message 108i. Upon receipt of the acceptance message 108i, the laptop (e.g., sink device) enters a power sink standby mode at laptop block 108t.

Supply block 108j initiates a ramp-up of the bus voltage to the explicitly contracted value (e.g., 20V). Additionally, the supply may issue a ready message 108k, wherein laptop block 108l exits the power sink standby mode. A current message 108m ramps the bus current to the negotiated power. Laptop block 108n detects a signal from a piezoelectric membrane of the adapter plug prior to an unplug event 1080. Laptop block 108p observes a pull-up resistance disconnection on the CC line and laptop block 108q determines whether the bus voltage has ramped down by 5V. If so, laptop block 108r deactivates the sink device FETs. Otherwise, laptop block 108s resets the CC disconnect state. Thus, laptop block 108r prevents a current arc from the adapter plug to the receptacle, reduces damage to the receptacle and/or adapter plug, and improves safety.

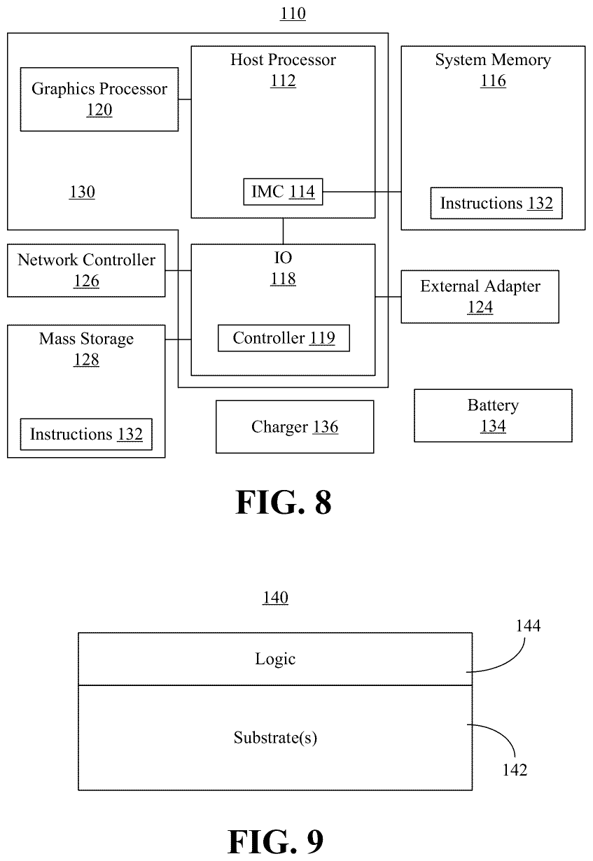

Turning now to FIG. 8, a performance-enhanced computing system 110 (e.g., source device) is shown. The system 110 may generally be part of an electronic device/platform having computing functionality (e.g., personal digital assistant/PDA, notebook computer, tablet computer, convertible tablet, desktop computer, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof.

In the illustrated example, the system 110 includes a host processor 112 (e.g., CPU) having an integrated memory controller (IMC) 114 that is coupled to a system memory 116. In an embodiment, an IO module 118 is coupled to the host processor 112. The illustrated IO module 118 communicates with, for example, a network controller 126 (e.g., wired and/or wireless), an external adapter 124, and mass storage 128 (e.g., hard disk drive/HDD, optical disc, solid-state drive/SSD, flash memory, etc.). In an embodiment, the external adapter 124 includes a plug that is inserted into a receptacle of the computing system 110, wherein the plug includes a piezoelectric membrane. Additionally, the computing system 110 may include a power delivery interface such as, for example, the power delivery interface 70 (FIG. 5), already discussed. Thus, the computing system 110 may include a bulk capacitor and a bus voltage line coupled to the receptacle and the bulk capacitor. The system 110 may also include a graphics processor 120 (e.g., graphics processing unit/GPU) that is incorporated with the host processor 112 and the IO module 118 into a system on chip (SoC) 130. The computing system 110 includes a charger 136 and a battery 134 that provides a battery output.

In one example, the mass storage 128 and/or the system memory 116 include instructions 132, which when executed by a controller 119 (e.g., PD controller), causes the controller 119 and/or the computing system 110 to implement one or more aspects of the method 100 (FIG. 6), already discussed. Thus, execution of the instructions 132 causes the controller 119 and/or the computing system 110 to detect a signal from a piezoelectric membrane of the adapter plug (e.g., adjacent to the receptacle), wherein the signal indicates user contact with the adapter plug, and disconnect the bulk capacitor from the receptacle in response to a disconnect condition associated with the user contact.

The computing system 110 is therefore considered performance-enhanced at least to the extent that disconnection of the bulk capacitor from the receptacle prevents a current arc between the adapter plug and the receptacle. Preventing arcing also reduces damage to the receptacle and/or adapter plug and improves safety.

FIG. 9 shows a semiconductor apparatus 140 (e.g., chip and/or package). The illustrated apparatus 140 includes one or more substrates 142 (e.g., silicon, sapphire, gallium arsenide) and logic 144 (e.g., transistor array and other integrated circuit/IC components) coupled to the substrate(s) 142. In an embodiment, the logic 144 and implements one or more aspects of the method 100 (FIG. 6), already discussed.

The logic 144 may be implemented at least partly in configurable or fixed-functionality hardware. In one example, the logic 144 includes transistor channel regions that are positioned (e.g., embedded) within the substrate(s) 142. Thus, the interface between the logic 144 and the substrate(s) 142 may not be an abrupt junction. The logic 144 may also be considered to include an epitaxial layer that is grown on an initial wafer of the substrate(s) 142.

### ADDITIONAL NOTES AND EXAMPLES

Example 1 includes a performance-enhanced computing system comprising a receptacle, a bulk capacitor, a bus voltage line coupled to the receptacle and the bulk capacitor, and a controller coupled to the bus voltage line and the receptacle, the controller including a set of instructions, which when executed by the controller, cause the controller to detect a signal from a piezoelectric membrane of an adapter plug adjacent to the receptacle, wherein the signal indicates user contact with the adapter plug, and disconnect the bulk capacitor from the receptacle in response to a disconnect condition associated with the user contact.
Example 2 includes the computing system of Example 1, wherein the instructions, when executed, further cause the controller to monitor the receptacle for the disconnect condition in response to the signal.
Example 3 includes the computing system of Example 2, wherein the disconnect condition includes a configuration channel line state change within a predetermined amount of time.
Example 4 includes the computing system of Example 2, wherein the disconnect condition includes a bus voltage reduction within a predetermined amount of time.
Example 5 includes the computing system of Example 1, further including one or more switches connected between the bulk capacitor and the receptacle, wherein to disconnect the bulk capacitor from the receptacle, the instructions, when executed, cause the controller to deactivate the one or more switches.
Example 6 includes the computing system of Example 1, further including an input capacitor connected to the receptacle, wherein the input capacitor is to remain connected to the receptacle while the bulk capacitor is disconnected from the receptacle.
Example 7 includes the computing system of Example 1, wherein the signal is detected via a configuration channel line and the instructions, when executed, further cause the controller to negotiate a power delivery setting with the adapter plug via the configuration channel line.
Example 8 includes the computing system of any one of Examples 1 to 7, wherein disconnection of the bulk capacitor from the receptacle prevents a current arc from the adapter plug to the receptacle.
Example 9 includes a performance-enhanced adapter plug comprising a housing, a plurality of contacts positioned within the housing, wherein the plurality of contacts includes one or more configuration channel contacts, and a piezoelectric membrane positioned on an external surface of the housing, wherein the piezoelectric membrane is electrically connected to the one or more configuration channel contacts.
Example 10 includes the adapter plug of Example 9, wherein user contact with the piezoelectric membrane is to generate a signal on the one or more configuration channel contacts.
Example 11 includes the adapter plug of Example 9, wherein the piezoelectric membrane is electrically connected to the one or more configuration channel contacts via an electrically conductive pillar.
Example 12 includes the adapter plug of Example 9, wherein the plurality of contacts is compliant with a Universal Serial Bus (USB) Type-C standard.
Example 13 includes the adapter plug of Example 12, wherein the adapter plug supports standard power range power delivery.
Example 14 includes the adapter plug of Example 12, wherein the adapter plug supports extended power range power delivery.
Example 15 includes the adapter plug of Example 9, wherein the plurality of contacts further includes one or more bus voltage contacts.
Example 16 includes the adapter plug of any one of Examples 9 to 15, further including a circuit board coupled to the plurality of contacts, and a wiring harness coupled to the circuit board.
Example 17 includes at least one computer readable storage medium comprising a set of instructions, which when executed by a computing system, cause the computing system to detect a signal from a piezoelectric membrane of an adapter plug, wherein the signal indicates user contact with the adapter plug, and disconnect a bulk capacitor from a receptacle adjacent to the adapter plug in response to a disconnect condition associated with the user contact.
Example 18 includes the at least one computer readable storage medium of Example 17, wherein the instructions, when executed, further cause the computing system to monitor the receptacle for the disconnect condition in response to the signal.
Example 19 includes the at least one computer readable storage medium of Example 18, wherein the disconnect condition includes a configuration channel line state change within a predetermined amount of time.
Example 20 includes the at least one computer readable storage medium of Example 18, wherein the disconnect condition includes a bus voltage reduction within a predetermined amount of time.
Example 21 includes the at least one computer readable storage medium of Example 17, wherein to disconnect the bulk capacitor from the receptacle, the instructions, when executed, cause the computing system to deactivate one or more switches connected between the bulk capacitor and the receptacle.
Example 22 includes the at least one computer readable storage medium of Example 17, wherein an input capacitor is to remain connected to the receptacle while the bulk capacitor is disconnected from the receptacle.
Example 23 includes the at least one computer readable storage medium of Example 17, wherein the signal is detected via a configuration channel line and the instructions, when executed, further cause the computing system to negotiate a power delivery setting with the adapter plug via the configuration channel line.
Example 24 includes the at least one computer readable storage medium of any one of Examples 17 to 23, wherein disconnection of the bulk capacitor from the receptacle prevents a current arc from the adapter plug to the receptacle.
Example 25 includes a method of operating a controller comprising detecting a signal from a piezoelectric membrane of an adapter plug, wherein the signal indicates user contact with the adapter plug, and disconnecting a bulk capacitor from a receptacle adjacent to the adapter plug in response to a disconnect condition associated with the user contact.
Example 26 includes an apparatus comprising means for performing the method of Example 25.

The technology described herein therefore extends the life cycle of power delivery plugs and receptacles without increasing the size of the bulk capacitor on the sink side. Indeed, a larger bulk capacitor would fail to address long-term reliability risks, add stress to the sink device FETs (e.g., due to larger inrush current during connection), and increase cost. Moreover, during AC mode of operation, the energy stored in a larger capacitor (e.g., 135 μF capacitor at a 5A maximum limit) may be used up for system performance.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a receptacle;
a bulk capacitor;
a bus voltage line coupled to the receptacle and the bulk capacitor; and
a controller coupled to the bus voltage line and the receptacle, the controller including a set of instructions, which when executed by the controller, cause the controller to:
detect a signal from a piezoelectric membrane of an adapter plug adjacent to the receptacle, wherein the signal indicates user contact with the adapter plug, and
disconnect the bulk capacitor from the receptacle in response to a disconnect condition associated with the user contact.

2. The computing system of claim 1, wherein the instructions, when executed, further cause the controller to monitor the receptacle for the disconnect condition in response to the signal.

3. The computing system of claim 2, wherein the disconnect condition includes a configuration channel line state change within a predetermined amount of time.

4. The computing system of claim 2, wherein the disconnect condition includes a bus voltage reduction within a predetermined amount of time.

5. The computing system of claim 1, further including one or more switches connected between the bulk capacitor and the receptacle, wherein to disconnect the bulk capacitor from the receptacle, the instructions, when executed, cause the controller to deactivate the one or more switches.

6. The computing system of claim 1, further including an input capacitor connected to the receptacle, wherein the input capacitor is to remain connected to the receptacle while the bulk capacitor is disconnected from the receptacle.

7. The computing system of claim 1, wherein the signal is detected via a configuration channel line and the instructions, when executed, further cause the controller to negotiate a power delivery setting with the adapter plug via the configuration channel line.

8. The computing system of claim 1, wherein disconnection of the bulk capacitor from the receptacle prevents a current arc from the adapter plug to the receptacle.

9. An adapter plug comprising:
a housing;
a plurality of contacts positioned within the housing, wherein the plurality of contacts includes one or more configuration channel contacts; and
a piezoelectric membrane positioned on an external surface of the housing, wherein the piezoelectric membrane is electrically connected to the one or more configuration channel contacts.

10. The adapter plug of claim 9, wherein user contact with the piezoelectric membrane is to generate a signal on the one or more configuration channel contacts.

11. The adapter plug of claim 9, wherein the piezoelectric membrane is electrically connected to the one or more configuration channel contacts via an electrically conductive pillar.

12. The adapter plug of claim 9, wherein the plurality of contacts is compliant with a Universal Serial Bus (USB) Type-C standard.

13. The adapter plug of claim 12, wherein the adapter plug supports standard power range power delivery.

14. The adapter plug of claim 12, wherein the adapter plug supports extended power range power delivery.

15. The adapter plug of claim 9, wherein the plurality of contacts further includes one or more bus voltage contacts.

16. The adapter plug of claim 9, further including:
a circuit board coupled to the plurality of contacts; and
a wiring harness coupled to the circuit board.

17. At least one computer readable storage medium comprising a set of instructions, which when executed by a computing system, cause the computing system to:
detect a signal from a piezoelectric membrane of an adapter plug, wherein the signal indicates user contact with the adapter plug; and
disconnect a bulk capacitor from a receptacle adjacent to the adapter plug in response to a disconnect condition associated with the user contact.

18. The at least one computer readable storage medium of claim 17, wherein the instructions, when executed, further cause the computing system to monitor the receptacle for the disconnect condition in response to the signal.

19. The at least one computer readable storage medium of claim 18, wherein the disconnect condition includes a configuration channel line state change within a predetermined amount of time.

20. The at least one computer readable storage medium of claim 18, wherein the disconnect condition includes a bus voltage reduction within a predetermined amount of time.

21. The at least one computer readable storage medium of claim 17, wherein to disconnect the bulk capacitor from the receptacle, the instructions, when executed, cause the computing system to deactivate one or more switches connected between the bulk capacitor and the receptacle.

22. The at least one computer readable storage medium of claim 17, wherein an input capacitor is to remain connected to the receptacle while the bulk capacitor is disconnected from the receptacle.

23. The at least one computer readable storage medium of claim 17, wherein the signal is detected via a configuration channel line and the instructions, when executed, further cause the computing system to negotiate a power delivery setting with the adapter plug via the configuration channel line.

24. The at least one computer readable storage medium of claim 17, wherein disconnection of the bulk capacitor from the receptacle prevents a current arc from the adapter plug to the receptacle.
